(19) United States
(12) Patent Application Publication
(10) Pub. No.: US 2002/0066700 A1
(43) Pub. Date: Jun. 6, 2002

(54) Bag-shaped filter insert made of filter paper

(76) Inventors: Rainer Dolfel, Minden (DE); Stephan Frank, Mohnesee (DE); Frank Ronald Jones, Porta Westfalica (DE)

Correspondence Address: VENABLE, BAETJER, HOWARD and CIVILETTI, LLP, P.O. Box 34385, Washington, DC, 20043-9998, US

(21) Appl. No.: 09/999,200

(22) Filed: Dec. 3, 2001

(30) Foreign Application Priority Data
Dec. 2, 2000 (DE) 100 59 971.0

(51) Int. Cl. B01D 39/18

(52) U.S. Cl. 210/497.3; 210/498; 210/500.1

(57) ABSTRACT

A bag-shaped filter insert made of filter paper for preparing aromatic extracts of coffee or tea includes an upper region and an adjoining bottom region. The bottom region has a lesser permeability than the upper region.

### CROSS-REFERENCE TO RELATED APPLICATION

This application claims the priority of German Application No. 100 59 971.0 filed Dec. 2, 2000 which is incorporated herein by reference.

### BACKGROUND OF THE INVENTION

The present invention relates to a bag-shaped paper filter insert for use in the preparation of aromatic extracts of coffee or tea.

filters of the above-outlined type have long been known and are primarily used for brewing coffee or tea in coffee makers or tea makers. The coffee or tea makers are provided with a filter receptacle into which the filter is inserted and filled with ground coffee or tea. After the coffee or tea maker is turned on, a predetermined amount of water is heated with a flow heater and is then allowed to flow into the filter insert. The filtrate then drains into a container provided underneath the filter receptacle.

The coffee or tea maker generally has a higher capacity than the filter receptacle or the filter insert. As a result, when making full use of the capacity of a coffee or tea maker during a brewing operation, the amount of water flowing through the filter receptacle provided with the filter insert is considerably higher than the capacity of the filter receptacle containing the filter insert.

For the above-mentioned reasons, conventional filter inserts are designed to prevent brewing water flowing into the filter insert from overflowing its upper edge. This is achieved by selecting, for the filter, a filter paper which has a filtration speed that securely prevents the brewing water level inside the filter receptacle from rising above its upper edges.

Since the speed at which the brewing water flows through the filtration device, composed of filter receptacle and filter insert, also depends on the type of coffee used as well as the fineness of the ground coffee, filter paper with relatively low filtration times has been used.

The above-described conditions lead to contact times between the brewing water and the aroma carrier which are relatively short, so that a larger amount of ground coffee is required to brew what is generally referred to as “strong” coffee.

### SUMMARY OF THE INVENTION

It is an object of the invention to provide an improved filter insert of the above-outlined type with which stronger brewed beverage may be made than has been possible so far, without increasing the quantity of the aroma carrier, and the brewing water is prevented from overflowing the upper edge of the filter insert.

This object and others to become apparent as the specification progresses, are accomplished by the invention, according to which, briefly stated, the filter insert is less permeable in a bottom region than in an adjoining upper region.

The present invention is based on the principle to provide the filter insert with areas of different permeability thus resulting in different filtration times at different filter locations. Consequently, a longer direct-contact time between the brewing water and an aroma carrier is ensured while, at the same time, the brewing water is prevented from overflowing the upper edge of the filter insert.

Because of the increased contact time as well as the better utilization of the aroma carrier, under identical conditions (same amounts of aroma carrier and/or water) as with conventional filters, a stronger beverage may be brewed when using a filter insert according to the invention.

As previously described, the danger of overflow is eliminated by adjusting the permeability of the filter insert in its upper region to such an extent that the brewing water can flow off faster than in its lower region. Although the brewing water flows off faster in the upper filter region, it still contacts the aroma carrier, and therefore the reduced extraction of the aroma carrier resulting from the faster outflow of the brewing water does not have an appreciable effect on the overall strength of the beverage.

### BRIEF DESCRIPTION OF THE DRAWINGS

FIG. 1 is a top plan view of a filter insert according to a preferred embodiment of the invention, shown in a non-installed, folded state.

FIG. 2 is a view similar to FIG. 1, showing another preferred embodiment of the invention.

### DESCRIPTION OF THE PREFERRED EMBODIMENTS

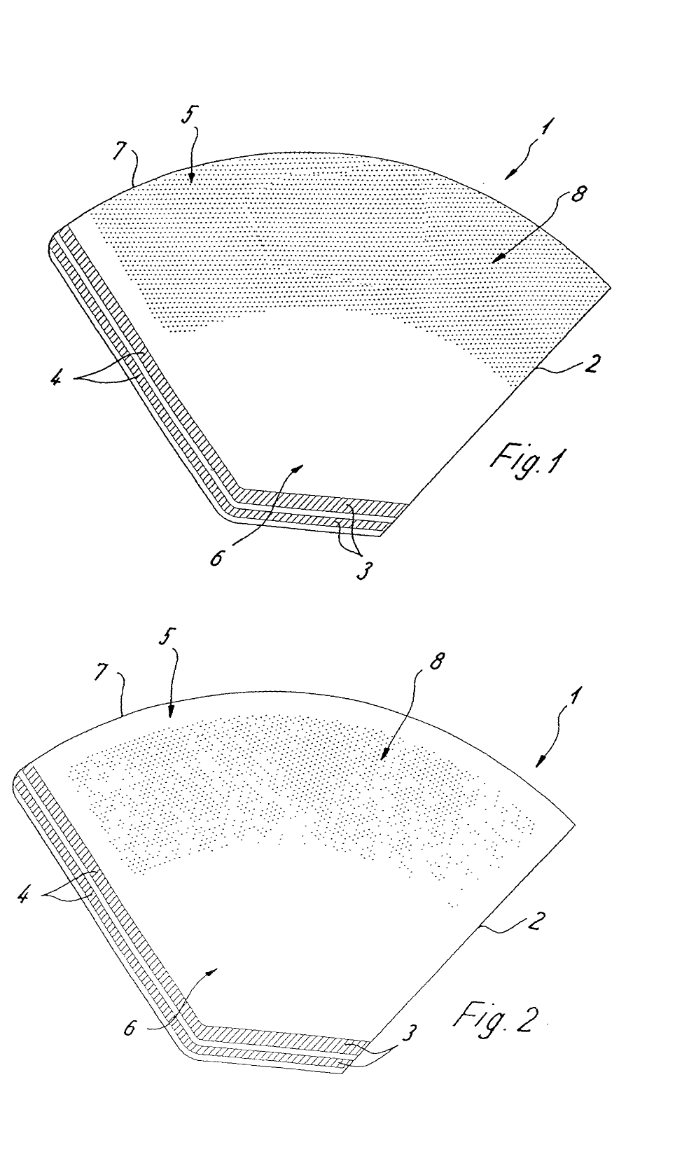

In FIGS. 1 and 2 a bag-shaped filter insert 1 is shown which is made of filter paper in a known manner and is designed for being installed in a filter receptacle of a beverage maker. The filter insert 1 has a folding edge 2, a bottom seam 3, a side seam 4, an upper region 5 including the upper filter edge 7 and a bottom region 6 adjoining the upper region 5.

The filter inserts 1 of FIGS. 1 and 2 are less permeable in the bottom region 6 than in the upper edge region 5. Thus, brewing water that flows into the installed filter insert 1 according to the invention is retained in the bottom region 6 longer than in the upper region 5. In this manner a very strong aromatic extract can be made without risking a brewing water overflow about the upper filter edge 7.

As concerns production technology, it is particularly easy to obtain different flow-through speeds at different filter areas and thus regions with different filtration times by providing the filter insert 1 with perforations forming a perforation zone 8 in the upper region 5. Thus, a filter paper according to the invention may be used which has a filtration time of more than 45 seconds, determined according to the Herzberg method.

According to the Herzberg method for measuring the filtration speed and the wet strength of filter paper types, a filter paper test sample with a test surface of 10 cm² is clamped into a test cylinder and is exposed to water under a predetermined water pressure. For testing the filtration speed, the testing pressure is set to 50 mm water column and the testing is performed at a water temperature of 20° C.±1° C. The water should have a water hardness of 2-10° dH.

The water flowing through the filter paper under the above defined external testing conditions drains through a drain channel into a measuring cylinder having a scale division of not more than 2 ml. The filtration time is measured with a stopwatch having a scale division of not more than 0.2 seconds. Based on these testing conditions, the filtration speed can be determined in addition to the filtration time. The filtration speed is computed as quotient of the filtration time and the filtrate volume collected in the measuring cylinder.

Advantageously, the free flow passage area formed by the perforations of the perforation zone 8 increases toward the upper edge 7 of the filter insert 1.

In the embodiment according to FIG. 1 the perforation zone 8 extends over the entire upper region 5 of the filter insert 1, up to the upper filter edge 7.

In the embodiment according to FIG. 2 the perforation zone 8 is recessed slightly from the upper edge 7 as well as the folding edge 2 and the side seam 4. As a result of such an arrangement, the mechanical stability of the filter insert in the upper region 5 is preserved to a large extent.

As an alternative, the perforation zone in the upper filter region 5 may be formed by embossing the region 5 such that the paper is deformed which may include the formation of holes. Such a perforation may be produced with a roller pair with which a particularly precise setting of the deformation and/or holes and thus the permeability of the filter paper can be obtained.

The geometric shape and size of the perforation zone 8 or an embossed perforation zone in the upper filter region 5 may vary; what is essential is that the overall permeability is sufficient to prevent an overflow.

It will be understood that the above description of the present invention is susceptible to various modifications, changes and adaptations, and the same are intended to be comprehended within the meaning and range of equivalents of the appended claims.

What is claimed is:

1. A bag-shaped filter insert made of filter paper for preparing aromatic extracts of coffee or tea, comprising
(a) an upper edge;
(b) an upper region including said upper edge; said upper region having a first permeability; and
(c) a bottom region adjoining said upper region; said bottom region having a second permeability less than said first permeability.

2. The filter insert according to claim 1, further comprising perforations forming a perforation zone in said upper region.

3. The filter insert according to claim 2, wherein said perforations together constitute a free flow passage area increasing toward said upper edge.

4. The filter insert according to claim 2, wherein said perforation zone extends up to said upper edge.

5. The filter insert according to claim 2, wherein said perforation zone is recessed from said upper edge.

6. The filter insert according to claim 2, further comprising side edges; said perforation zone is recessed from said side edges.

7. The filter insert according to claim 1, further comprising embossments forming a perforation zone in said upper region.

8. The filter insert according to claim 1, wherein said filter insert has a filtration time in excess of 45 seconds as determined by Herzberg's method.
